(19) United States
(12) Patent Application Publication
(10) Pub. No.: US 2012/0278162 A1
(43) Pub. Date: Nov. 1, 2012

(54) CONDUCTING AN AUCTION OF SERVICES RESPONSIVE TO POSITIONAL SELECTION

(75) Inventors: Jiantao Sun, Beijing (CN); Jun Yan, Beijing (CN); Lei Ji, Beijing (CN); Ning Liu, Beijing (CN); Peng Bai, Beijing (CN); Xuedong Huang, Bellevue, WA (US); Xiaochuan Ni, Beijing (CN); Zhimin Zhang, Beijing (CN); Zheng Chen, Beijing (CN)

(73) Assignee: MICROSOFT CORPORATION, Redmond, WA (US)

(21) Appl. No.: 13/097,081

(22) Filed: Apr. 29, 2011

(51) Int. Cl. G06Q 30/00; G06F 17/30; G06F 15/16

(52) U.S. Cl. 705/14.49; 709/203; 707/706; 707/E17.108

(57) ABSTRACT

Various technologies pertaining to provision of graphical data to a client computing device responsive to receipt of a positional selection on a web page by a user of a client computing device are described herein. A computer-executable application executing on the client computing device detects that the user has selected a certain position on the web page, wherein this application is not called by code of the web page. The position is transmitted to an ad server, which conducts an auction for display space on the client computing device based at least in part upon the detection of the certain position.

### BACKGROUND

Oftentimes a user that browses web pages that are accessible by way of the Internet wishes to receive information pertaining to particular goods, services, or entities. Accordingly, in an example, the user may proffer a query to a search engine, wherein such query is crafted by the user in order to obtain certain information. Search engines have attempted to monetize the informational requests of users by selling advertising space to advertisers, such that an advertisement that is related to the query is displayed together with search results returned by the search engine. In general, the search engine accepts bids from advertisers whose content is relevant to the information retrieval intent of the user, wherein such information retrieval intent is represented by the query submitted by the user. For instance, if the user provides a search engine with the query “vacations in California”, an online travel agent may wish to advertise to the issuer of the query to inform the user of the services of the online travel agent.

Publishers of content have also been able to monetize such content by selling advertising space on a web page to advertisers that are advertising goods or services that are related to the content. With more specificity, the publisher/owner of content of a web page can contract with an advertisement delivery engine. The web page as a whole is utilized to represent the information retrieval intent of a user that is viewing the web page, and an advertisement can be selected for display to a viewer of the web page based at least in part upon content included in the web page.

In some cases, however, the entirety of content of a web page may not be particularly relevant to interests of a user viewing such web page. For example, a web page may include a plurality of different types of information, wherein the user may be interested in only a small portion of such information. Conventionally, if the user desires to obtain additional information with respect to content on a web page, the user can open up a new browser window, direct the browser to a search engine, and provide the search engine with a query that represents the information retrieval intent of the user. This requires, however, that the user take the time to open a new browser window, formulate a new query, and parse through search results to retrieve the desired information.

### SUMMARY

The following is a brief summary of subject matter that is described in greater detail herein. This summary is not intended to be limiting as to the scope of the claims.

Described herein are various technologies pertaining to providing a user with content based at least in part upon positional information received from a user, wherein the positional information is indicative of a position on a web page selected by the user. In an example, a user of a client computing device can cause a web page to be loaded in a web browser. The client computing device may be a tablet computing device, a personal computing device, a portable telephone, or other suitable device that can execute a web browser. When viewing the web page, the user of the client computing device may determine that certain content is of interest to the user. The user may then use some suitable selecting mechanism to make a selection of such content. For example, the user may utilize a mouse pointer to select a position on the web page corresponding to the content of interest. In other examples, the user may utilize a touch sensitive display of a tablet computer or mobile telephone, may use a gesture that can be captured by a camera, or other suitable selection mechanism/technique.

A computer-executable application that is executing on the client computing device can determine a position of the selection in the web page. In an example, this computer-executable application may not be called by code of the web page. Thus, for instance, the application may be a plug-in to a browser that is configured to monitor positions on the web page that may be selected by the user. In another example, the application may be a portion of an operating system that is configured to detect positional selections by the user. In an example, such positional selection by the user may be user-formulation of a circle or other enclosure, wherein the circle encompasses content of interest to the user.

The positional information, which is indicative of a position on the web page selected by the user, may then be transmitted by way of a network to a server, wherein such positional information is utilized to select content for provision to the user. In an example, this content may be an advertisement that is relevant to content of the web page at the position selected by the user. In another example, the content provided to the user may be a service, such as a service provided by a mapping application, a hyperlink to another web page that is relevant to the content on the web page corresponding to the position selected by the user, or other suitable service. For instance, responsive to receipt of the positional information from the client computing device, an auction can be undertaken to select particular graphical data (describing services, such as advertisements) for transmittal back to the client computing device. As indicated above, such an auction can be undertaken based at least in part upon the received positional information. In an example, the web page being viewed by the user may have a known structure/format. For instance, large websites, such as websites managed by large retailers, comprise a plurality of web pages that have a substantially similar layout/structure. Therefore, for example, a name of a product may consistently be in a first position on a web page belonging to the website, an image of a product may consistently be in a second position on a web page belonging to the website, a price of a product may consistently be in a third position on a web page belonging to the website, and this format/structure can be consistent across web pages that describe products that are offered for sale by the retailer.

Accordingly, if the positional information is received when the user is viewing a web page of such retailer, the general structure/layout of a web page can be known a priori. Therefore, the content corresponding to the position selected by the user can be inferred, and an auction for presentment of graphical data describing services can be conducted based at least in part upon the inferred content on the web page at the position selected by the user. More specifically, a measure of relevance between inferred content on the web page at the position selected by the user and an advertisement/service that desirably displayed in connection with the position selected by the user can be computed, and a particular advertisement/service can be selected for transmittal to the client computing device based at least in part upon the computed measure of relevance. Moreover, an advertisement/service can be selected for transmittal to the client computing device based at least in part upon bid amounts set forth in bids by prospective service providers/advertisers.

The graphical data provided to the client computing device may be in the form of an in-line pop-up that comprises, for instance, a link to a service provider, an advertisement, an image, a video, or the like. Additionally or alternatively, the graphical data may be shown in graphical relation to the web page, such as in another browsing window. The user may then choose to interact with the graphical data that was provided to the client computing device. This can cause, for example, a new browser window or tab to be activated.

Other aspects will be appreciated upon reading and understanding the attached figures and description.

### BRIEF DESCRIPTION OF THE DRAWINGS

FIG. 1 is a functional block diagram of an exemplary system that facilitates providing graphical data to a user based at least in part upon a position on a web page selected by the user.

FIG. 2 is an exemplary graphical user interface that illustrates a positional selection on a web page by a user and graphical data provided to the user responsive to the positional selection.

FIG. 3 is a functional block diagram of an exemplary client computing device.

FIG. 4 is a functional block diagram of exemplary system that facilitates conducting an auction for providing graphical data to a client computing device based at least in part upon a position on a web page selected by a user.

FIG. 5 is a functional block diagram of an exemplary system that facilitates providing graphical content to a user that selects a particular position on a television screen.

FIG. 6 is a flow diagram that illustrates an exemplary methodology for causing graphical data to be provided to a client computing device based at least in part upon a selection of a position on a web page by the user of the client computing device.

FIG. 7 is a flow diagram that illustrates an exemplary methodology for causing graphical data to be displayed at a client computing device, subsequent to receipt of a selection of a position on a web page from a user of the client computing device.

FIG. 8 is a flow diagram illustrates an exemplary methodology for conducting an auction amongst prospective advertisers based at least in part upon a position on a web page selected by a user.

FIG. 9 is an exemplary computing system.

### DETAILED DESCRIPTION

Various technologies pertaining to providing graphical data describing services responsive to a user selecting a position on a web page will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

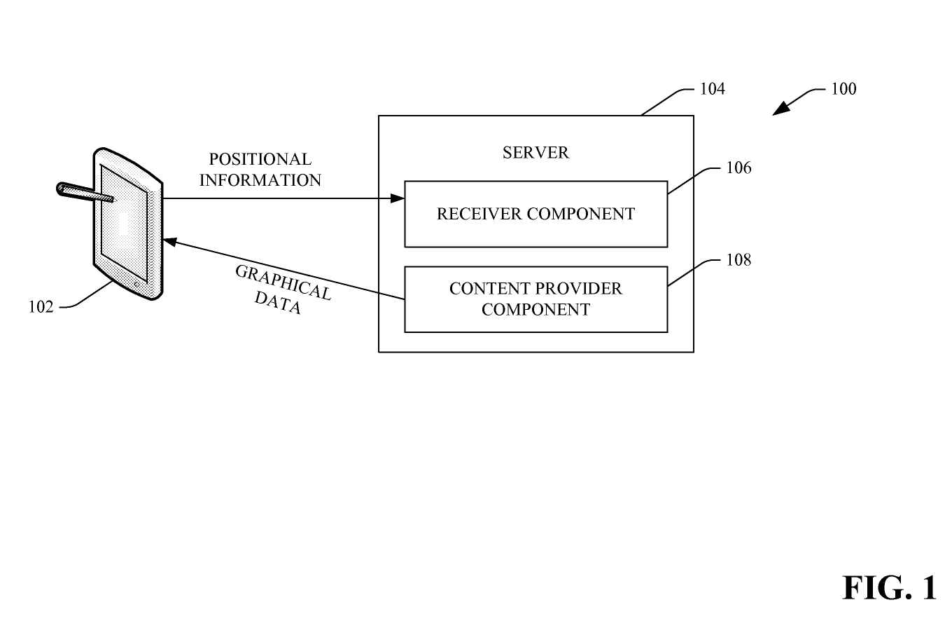

With reference now to FIG. 1, an exemplary system 100 that facilitates providing graphical data to a client computing device based at least in part upon a position on a web page selected by a user of the client computing device is illustrated. The system 100 comprises a client computing device 102. As shown, the client computing device 102 may be a tablet computing device, wherein a user of such computing device 102 can interact with content displayed on a display screen thereof through utilization of a stylus. It is to be understood, however, that the client computing device 102 may be any suitable computing device that is configured with functionality that allows display of web pages to a user. Therefore, the client computing device 102 may be a desktop computer, a laptop computer, a personal digital assistant, a portable telephone, or the like. Pursuant to an example, and as will be described in greater detail herein, the client computing device 102 can have a browser executing thereon, which has loaded a web page for display to the user. Upon reviewing the web page, the user may be interested in a particular portion of such web page. The user may then select a position on the web page that corresponds to the portion of interest. For example, in making such selection, the user may utilize a stylus, a finger, a touch, a gesture, a mouse, or the like to select the position in the web page that corresponds to content that is of interest to the user. In a particular example, the user can encircle the content that is of interest to the user. Other mechanisms for selecting content of interest, such as underlining, are contemplated.

The client computing device 102, as will be described in greater detail herein, may have a computer executable application executing thereon that is configured to monitor positions on web pages selected by the user. In an example, such application may be a plug-in to a web browser that is being utilized to display the web page to the user of the client computing device 102. Alternatively, the application may be an operating system that is configured to monitor interaction with the display of the client computing device 102 and determine a position on the display that has been selected by the user. In any event, it is to be understood this application executing on the client computing device 102 is not called by code of the web page that is being viewed by the user. Therefore, for example, the application is not JavaScript code that is called by the web page, is not a hyperlink embedded in the web page, etc. The aforementioned application may then be configured to cause positional information to be transmitted by way of a network connection to a server 104. Again, it is to be understood that the code of the web page being viewed by the user on the client computing device 102 is not utilized to transmit the positional information to the server 104.

The server 104 comprises a receiver component 106 that receives the positional information from the client computing device 102. As described above, the positional information indicates a position on the web page that has been selected by the user of the client computing device 102. Moreover, the positional information is received from an entity other than the web page (e.g., is received from an application executing on the client computing device 102 that is not called by code of the web page). A content provider component 108 is in communication with the receiver component 106, and causes graphical data to be transmitted to the client computing device 102 for display in graphical relation to the position on the web page selected by the user, wherein the content provider component 108 selects the graphical data for transmittal to the client computing device 102 based at least in part upon the positional information received from the client computing device 102. As will be described in greater detail below, the content provider component 108 can be configured to conduct an auction in connection with selecting the graphical data to be transmitted for display on the client computing device 102 corresponding to the position selected on the web page by the user. Therefore, for example, the graphical data may correspond to an advertisement that is related to content that is at the selected position on the web page. In another example, the graphical data can relate to a service that may be provided to the user of the client computing device 102, wherein the service is relevant to content on the web page corresponding to the position on such web page selected by the user. Additional detail pertaining to an auction that can be conducted by the content provider component 108 will be set forth below.

For purposes of explanation, an exemplary utilization of the system 100 is described. This example, however, is not intended to be limiting as to the scope of the claims. The user of the client computing device 102 may cause a web page corresponding to a digital camera, for instance, to be loaded in a web browser and displayed to the user. This web page may be the web page at a manufacturer's website, and may include an image of the digital camera and a suggested manufacturer's retail price of the digital camera. The user of the client computing device 102 may be interested in price of the digital camera as advertised by several retailers. Accordingly, the user of the client computing device 102 may encircle the price in the web page through a stylus, touch, mouse pointer, gesture, or the like. This encircling of the price can be captured as a selection of a particular position on the web page, and can be transmitted from the client computing device 102 as the positional information to the server 104 by way of, for instance, an Internet connection.

The content provider component 108 can receive such positional information, and through one or more mechanisms, can infer the content corresponding to the position of the web page selected by the user. Additional detail pertaining to content inference is provided below. A plurality of bids from a plurality of different service providers (including advertisers) may be received, and graphical data set forth by such service providers can be selected for display on the client computing device 102 by the content provider component 108 based at least in part upon bid amounts set forth by the bidders, as well as relevance of the inferred content with the graphical data set forth by the service providers. Continuing with the above example, the content provider component 108 can select an advertisement of a retailer that wishes to advertise the price of the digital camera at a store of the retailer to the user of the client computing device 102. This advertisement can be transmitted as the graphical data from the content provider component 108 to the client computing device 102, wherein, for instance, it can be displayed in graphical relation to the position in the web page selected by the user as an in-line popup. Content of such in-line popup, for example, can included identity of the retailer that is selling the digital camera, price of the digital camera at the retailer, a hyperlink that directs a web browser to a website of the retailer (e.g., to a web page of a website of the retailer that is dedicated to the digital camera). Therefore, the in-line popup may include a hyperlink that can direct the user of the client computing device 102 to a web page that allows the user to purchase the digital camera online from the retailer.

In another example, the user of the client computing device 102 can cause the browser executing thereon to load a web page that describes films, wherein such web page includes a name of a film, title of the film, actors in the film, awards won by the film, etc. The user of the client computing device 102 may encircle the title of the film on the web page, and the application executing on the client computing device 102 can capture such selection as the positional information. This positional information is transmitted to the server 104, where it is received by the receiver component 106. Content corresponding to the selected position can be inferred, and bids pertaining to such position can be received from a plurality of prospective service providers. A winning service provider may then have graphical data that includes or describes a service provided by the service provider to be transmitted to the client computing device 102, where such graphical data can be displayed in graphical relation to the selected position on the web page (the title of the film).

For instance, one of the service providers may be a company that specializes in film rentals, and the graphical data can include data pertaining to renting the selected film from such film rental company. Pursuant to an example, if the user of the client computing device 102 subscribes to a service provided by the film rental company, the user can, through a single click in an in-line pop-up presented to the user of the client computing device 102, cause the film to be added to a film rental queue. Therefore, rather than the user of the client computing device 102 having to open up a new browser window, direct the browser to load a web page corresponding to the movie rental service, conduct a search on such service for the film of interest, and thereafter indicate a desire to rent the film, the user can simply select the position on the web page corresponding to the title of the film, and the rental service provider may automatically provide a single link to cause the film to be added to the rental queue of the user. Other services/advertisements will be readily contemplated by those skilled in the art.

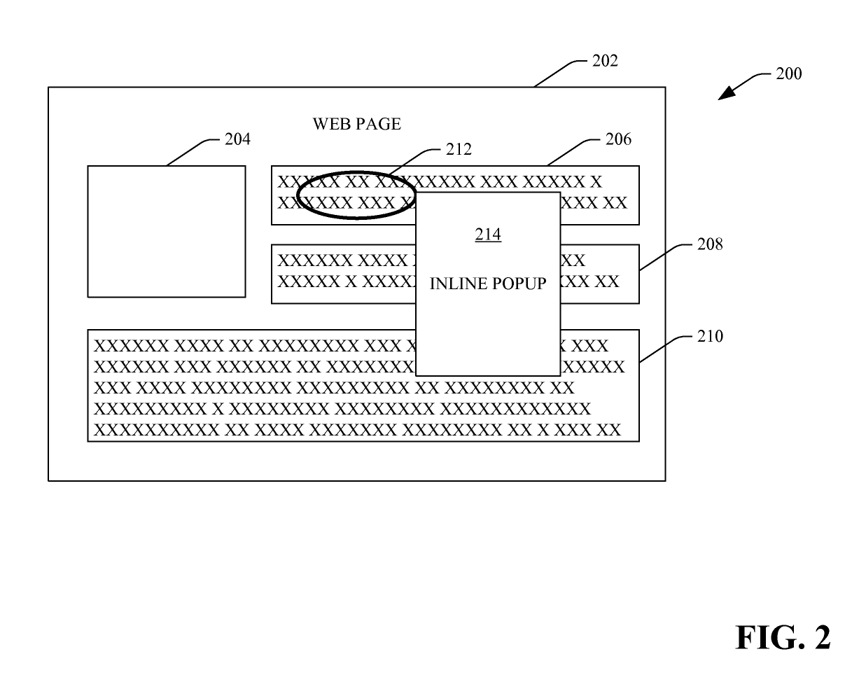

With reference now to FIG. 2, an exemplary graphical user interface 200 that illustrates an experience from the perspective of a user of the client computing device 102 when selecting a position on a web page is illustrated. The graphical user interface 200 includes a web page 202 that is loaded into a web browser on the client computing device 102. Pursuant to an example, the web page 202 may have a known structure/layout. For instance, the web page 202 may be a page in a website that has relatively high traffic, wherein web pages on such websites are known to have a certain structure/layout. A website corresponding to a relatively large retailer, for example, will have a plurality of web pages that are configured to describe certain products, and each of such web pages may have a particular layout/structure that is consistent across web pages. In another example, a wiki may have a particular layout/structure across different web pages. In this example, the web page 202 can comprise a first portion 204 that includes an image of a product, a second portion 206 that includes a title of the product, a third portion 208 that includes a description of the product, and a fourth portion 210 that includes user reviews of such product.

The user may select a particular position by encircling content in the web page. In this exemplary graphical user interface 200, the user has encircled content in the portion 206 of the web page that includes a title of a product. This is shown by way of the circular enclosure 212. Positional information describing the position of the circular enclosure 212 on the web page 202 can be transmitted to the server 104 as described above. Thereafter, an in-line pop-up 214 can be presented in graphical relation to the selected position on the web page 202. Again, this in-line pop-up 214 can include a hyperlink, which may direct a user to a web page corresponding to a particular entity or service, may include additional information pertaining to content that is enclosed in the enclosure 212, or the like. Therefore, the user can receive a service or description of a service that pertains to the content on the web page that has been enclosed by the enclosure 212 without having to open up a new browser window and direct such browser to a different web page. The in-line popup 214 can include one or more buttons that allow the in-line popup 214 to be collapsed or closed after the information has been consumed by the user or the service has been performed. Additionally or alternatively, the graphical data can be presented as an entirely new browser window rather than as an in-line popup. Other mechanisms for providing graphical content in graphical relation to the enclosure 212 are contemplated.

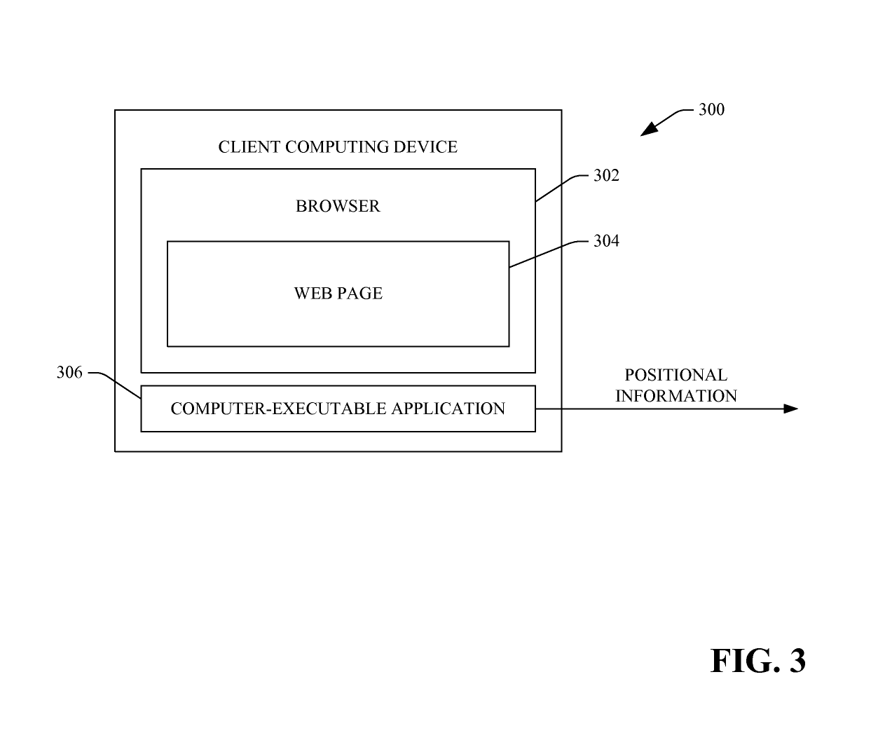

With reference now to FIG. 3, a functional block diagram of the client computing device 102 is illustrated. The client computing device 102 has a browser 302 installed thereon. The browser 302 is configured to load and display a web page 304 on a display screen of the client computing device 102.

The client computing device 102 may also comprise a computer-executable application 306 that is configured to ascertain a position on the web page 304 that is selected by the user. In an example, such application 306 may be installed as a plug-in to the browser 302. Additionally or alternatively, the computer-executable application 306 may be a portion of an operating system that is installed on the client computing device 102. The computer-executable application 306 is configured to monitor user interaction with the web page 304, to detect when the user selects a particular position on the web page 304 in order to obtain additional information pertaining to content that corresponds to the position of the selection on the web page 304 made by the user. If the computer-executable application 306 is installed as a plug-in to the browser 302, a depressible button may be existent in the browser that allows the user to turn on and off the functionality that corresponds to the computer-executable application 306. The ability to turn on and off the application 306 may prevent confusion in connection with determining whether the user wishes to select a hyperlink or other interactive portion of the web page 304, rather than selecting a position of such web page 304.

If the application 306 is a portion of an operating system of the client computing device 102, then again, such application 306 can be turned on and off at the desire of the user. If the computer-executable application 306 is a portion of the operating system of the client computing device 102, for instance, and the client computing device 102 has a touch sensitive display screen, the application 306 may be configured to monitor screen coordinates that are encircled by the user, and can further normalize such screen coordinates to correspond to a position on the web page 304. Subsequent to receiving a selection of the position, the computer executable application 306 can be configured to transmit the positional information to the server 104.

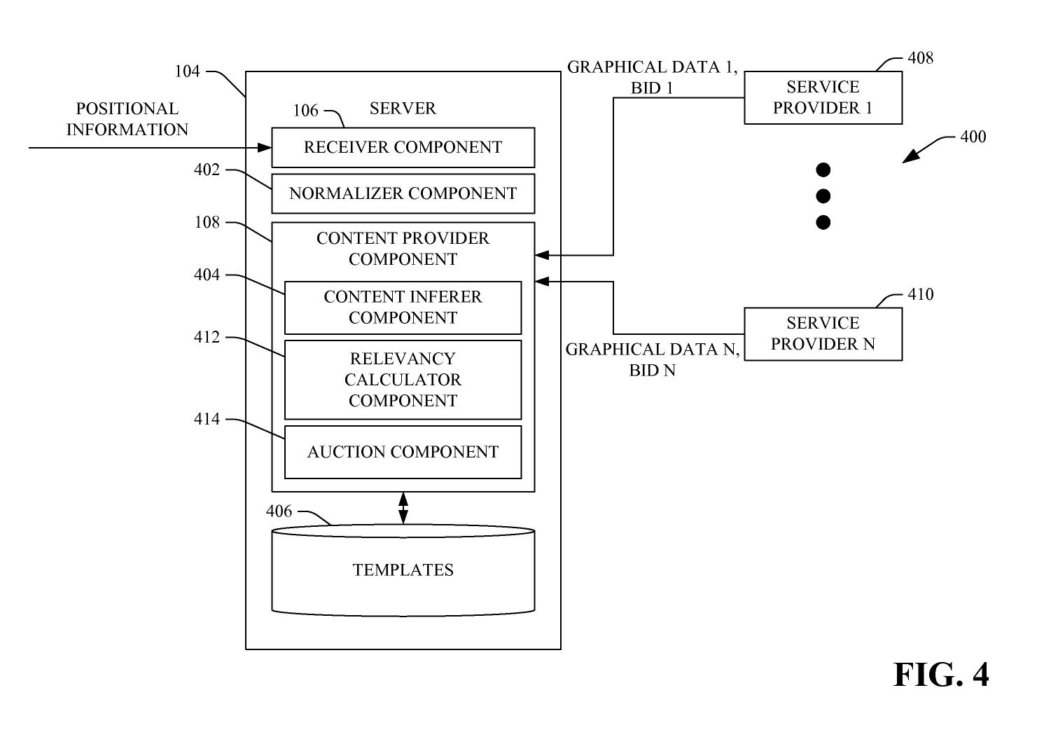

Turning now to FIG. 4, an exemplary system 400 that facilitates conducting an auction amongst service providers based at least in part upon positional information received from a client computing device is illustrated. The system 400 comprises the server 104, which includes the receiver component 106 that receives the positional information corresponding to a position on a web page selected by a user of the client computing device 102. The server 104 may optionally include a normalizer component 402 that is configured to normalize the positional information, such that, for instance, content corresponding to the position selected by the user can be ascertained regardless of a type of computing device that was utilized to view the web page. Pursuant to an example, a web page may be displayed differently on a mobile telephone when compared to the web page displayed on a personal computer. The normalizer component 402 can be configured to normalize, for instance positional coordinates, such that differences in devices utilized to display web pages are taken into consideration. It is to be understood that the normalizer component 402 is optional, as some service providers may wish to provide graphical content only to particular types of client devices.

The server 104 additionally comprises the content provider component 108 that, as described above, causes graphical data to be transmitted to the client computing device 102 based at least in part upon the positional information received by the receiver component 106. For instance, the content provider component 108 can include a content inferer component 404 that can infer content on the web page that corresponds to the position on the web page selected by the user of the client computing device 102. Pursuant to an example, the positional information received by the receiver component 106 can include an indication of a web page being viewed by the user when the selection of the position was made by such user. The content inferer component 404 can determine if such web page has a known structure/layout (e.g., conforms to some form of template).

For instance, the content inferer component can access a data store 406 that resides on the server 104 or is accessible to the server, wherein the data store 406 comprises a plurality of templates corresponding to certain websites. Therefore, if the web page being viewed by the user is a page in a website for which a template exists in the data store 406, the content inferer component 404 can access such template and infer the content of the web page at the position selected by the user based at least in part upon the template. Accordingly, for example, if the URL of the web page indicates that the subject of the web page is a particular entity, and the template indicates that the position selected by the user corresponds to a title of the entity, than the content inferer component 404 can infer that the position on the web page selected by the user is the title of the entity. In another example, if the URL of the web page indicates that the web page corresponds to a particular product, and the template indicates that the location selected by the user is generally a position where price of products is displayed, then the content inferer component 404 can infer that the content that corresponds to the position in the web page selected by the user is the price of the product.

In still yet another example, the application 306 executing on the client computing device 102 can be configured to capture an image of content that is encircled by the user and transmit such image to the server 104 as a portion of the positional information. The content inferer component 404 can include object character recognition functionality that allows text in the selected position on the web page to be translated to machine-readable text, and thereafter the content inferer component 404 can utilize, for instance, natural language processing functionality to infer the content that corresponds to the position on the web page selected by the user. In a similar example, the user may select an image on the web page and the application 306 executing thereon can be configured to capture such image and transmit the image as a portion of the positional information to the server 104. The content inferer component 404 can include image processing functionality to determine an entity that is captured in the image. Through utilization of such image processing functionality, the content inferer component 404 can infer an identity of the entity selected by the user on the web page.

In another example, the content inferer component 404 can receive the positional information and an identity of the web page being viewed by the user at the client computing device 102, and can access a search engine index and retrieve a cached version of web page from the search engine index. Pursuant to an example, positions on the cached web page can be mapped to certain content, and the content inferer component 404 can infer the content on the web page being viewed by the user based at least in part upon the content in the cached web page at the position selected by the user.

The system 400 further comprises a plurality of service providers 408-410 that wish to submit bids for providing graphical data to particular positions of web pages. For instance, these bids can be predefined for particular positions on web pages, regardless of the inferred content on such web pages. Alternatively, the service providers 408-410 can submit bids only after the content inferer component 404 has inferred content corresponding to the position on the web page selected by the user, wherein an amount of such bids or the bids themselves are conditional upon the content being directed to certain topic(s). In this manner, the service providers 408-410 can submit bids similarly as to how advertisers submit bids with respect to queries provided to search engines. Pursuant to an example, the first service provider 408 can submit a first bid for causing first graphical data (e.g., an advertisement, service, or information descriptive of a service) to be transmitted to the client computing device 102, and the nth service provider 410 can submit an nth bid for causing nth graphical data to be transmitted to the client computing device 102 for display in graphical relation to the selected position of the web page. Each of these bids can be packaged with a summary that identifies the content of the graphical data (e.g., description of services) that is desirably transmitted to the client computing device 102. Therefore, for example, the first bid provided by the first service provider 408 can include tags or metadata that describes the services that are represented by the graphical data that is desirably transmitted to the client computing device 102.

The content provider component 108 can further include a relevancy calculator component 412, which can receive the content of the position on the web page inferred by the content inferer component 404, and can additionally receive the summaries of the services that are desirably provided to a user from the service providers 408-410, and may compute a relevancy of such services to the inferred content based upon the inferred content and the summaries. Therefore, for example, the first bid can be assigned a first relevancy score by the relevancy calculator component 412, and the nth bid can be assigned an nth relevancy score by the relevancy calculator component 412.

The content provider component 108 can further comprise an auction component 414 that is configured to execute an auction for display space on the client computing device for presentation of the graphical data desirably provided to the user by the service providers 408-410. Pursuant to an example, the auction component 414 can select a winner of the auction for such space based at least in part upon the positional information received at the receiver component 106. Additionally, the auction component 414 can select a winner of the auction for such space based at least in part upon amounts of bids set forth by the service providers 408-410. Moreover, the auction component 414 can select a winner of the auction based at least in part upon relevancy scores assigned to bids of the service providers 408-410 by the relevancy calculator component 412. The graphical data corresponding to the winning bid can be caused to be transmitted to the client computing device 102 by the content provider component 108, where it can be displayed thereon in graphical relation to the selected position of the web page to the user.

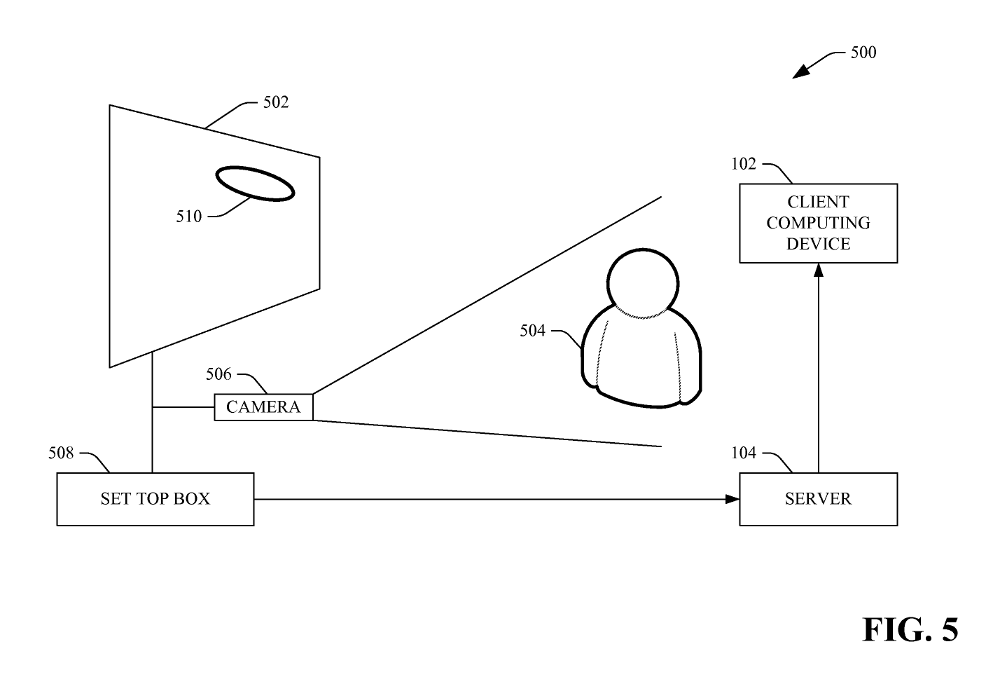

With reference now to FIG. 5, an exemplary system 500 that facilitates causing graphical data pertaining to a position on a display selected by a user is illustrated. The exemplary system 500 comprises a television 502 that is displaying video content, for example, to a user 504. The system 500 further comprises a camera 506 that is configured to capture motion/gestures of the user 504 with respect to the video content displayed on the television 502. For instance, the camera 506 can include an RGB camera and an infrared camera to detect depth, for example. A set top box 508 can be in communication with the television 502 and the camera 506, and can determine a position on the television selected by the user 504 based at least in part upon gestures captured by the camera 506. For instance, the user 504 can make a pointing gesture towards the television 502 at a particular position, and may then rotate the pointing gesture circularly to select certain content. The set top box 508 can receive the positional information (represented by an enclosure 510 on the television) and can assign a timestamp to such positional information. The positional information and timestamp can be transmitted to the server 104 by way of a suitable network connection.

Prospective service providers/advertisers may have previewed the content that is being viewed by the user 504 on the television 502, and may have chosen to bid on certain positions on the television 502 at particular times to provide services/content to the user 504. Pursuant to an example, the user 504 may be watching a television program, wherein an actor thereon is wearing a certain type of sunglasses. The user 504 may make a gesture towards the television 502 that encircles the sunglasses worn by the actor. This positional information and timestamp can be captured by the set-top box 508 and transmitted to the server 104. At the server 104, an auction can be conducted, which may allow the manufacture of the sunglasses selected by the user to present content to the user 504 on the television 502 that indicates to the user 504 the identity of such sunglasses and where these sunglasses can be purchased. Alternatively, a retailer that specializes in selling sunglasses of that brand or competitive sunglasses may wish to provide an advertisement for display to the user 504. This advertising data can be transmitted back to the set-top box 508, where the set-top box 508 can be configured to cause the advertisement to be presented on the television 502 for consumption by the user 504.

In another exemplary embodiment, if the set-top box 508 is not configured to cause graphical overlays to be presented in a video stream shown on the television 502, the user 504 can register the client computing device 102 with the server 104. Responsive to the user 504 selecting the position as indicated by the circular enclosure 510, the server 104 can conduct the aforementioned auction and can cause graphical data of a winning service provider to be transmitted to the client computing device 102 for consumption by the user 504. This allows the user 504 to receive additional information pertaining to video content displayed to the user 504 on the television 502.

In yet another example, a television program displayed on the television 502 may include text or a reference to a particular geographic location. The user 504 can make a gesture that is intended to encompass such geographical location, and this gesture can be captured by the camera 506. The set top box 508 can transmit the positional information and corresponding timestamp to the server 104, which can then cause an auction to be undertaken with respect to service providers that wish to provide the user 504 with, for instance, a map of the region, travel directions from a current location of the user 504 to the location discussed or represented on the television 502, etc.

While not shown, a service provider can be provided with a system that facilitates indicating to the server 104 which positions on web pages are desirably bid upon by such service provider. For instance, a specialized browser can be provided to the service provider that allows the service provider to indicate positions on web pages, wherein the service provider desires to provide graphical data relating to certain services with respect to the selected positions on the web pages. The service provider can indicate their interest in such position, for example, across all web pages that have a substantially similar layout/structure. Thereafter, as described previously, the content provider component 108 can be configured to ascertain whether the services set forth by the service provider are relevant to the content corresponding to the selected position on the web page from the user.

Additionally or alternatively, the service provider can specify certain particular web pages with which they are interested in providing services if a user selects certain positions. Moreover, the service provider can indicate that services are desirably provided only for a particular type of client computing device. For instance, a mapping application may only wish to provide directions to mobile devices rather than to a desktop computer. Additionally or alternatively, the service provider can be provided with an exemplary web page, and can select one or more positions on such web page, where the service provider wishes to provide graphical data pertaining to services if a user selects such positions. These selected positions can be normalized across different devices, such that the positions desirably advertised are consistent regardless of a type of client device utilized to consume the web page.

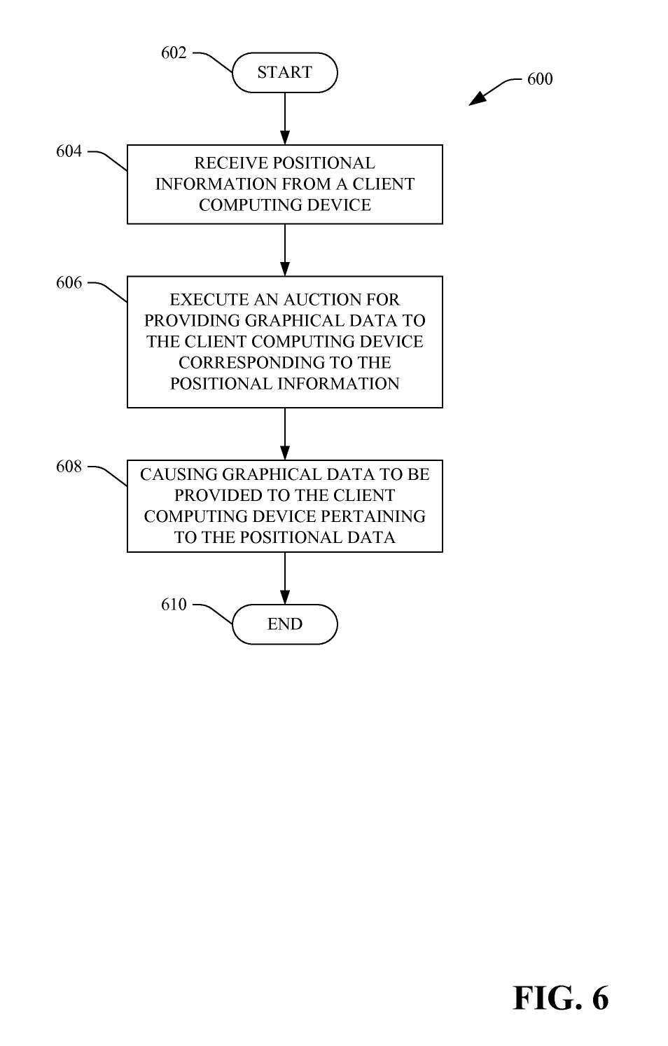

With reference now to FIGS. 6-8, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

With reference now to FIG. 6, an exemplary methodology 600 that facilitates causing graphical content to be transmitted to a client computing device is illustrated. For instance, the methodology 600 can be configured for execution on the server 104. The methodology 600 starts at 602, and at 604 positional information is received from a client computing device. As indicated previously, the positional information indicates a position on a web page being viewed by a user that has been selected by the user at the client computing device. Moreover, this positional information is received from an entity other than the web page. This entity may be a computer executable application that is not called by code of the web page.

At 606, an auction is executed for providing graphical data pertaining to content of the web page that corresponds to the position on the web page selected by the user. For instance, several service providers may wish to provide graphical data to the user corresponding to the position on the web page selected by the user. The winner of the auction can be determined based at least in part upon bid amounts, relevancy of the services to content that is inferred to correspond to the position in the web page selected by the user, the positional information received at 604, etc.

At 608, graphical data pertaining to the content that corresponds to the position on the web page is caused to be transmitted to the client computing device for display thereon. Again, this graphical data can be caused to be transmitted to the client computing device based at least in part upon the positional information received from the client computing device at 604. The methodology 600 completes at 610.

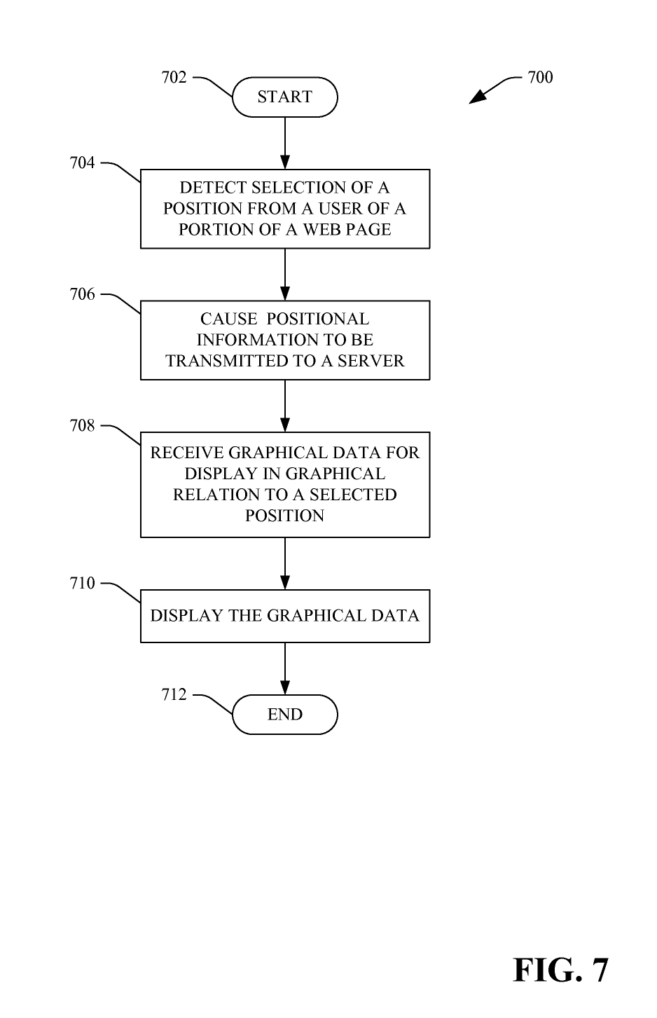

Turning now to FIG. 7, an exemplary methodology 700 that facilitates causing positional information to be transmitted to a server is illustrated. For instance, the methodology 700 may be configured for execution on the client computing device 102. The methodology 700 starts at 702, and at 704 a selection of a position from a user of a portion of a web page is detected. For instance, it can be detected that the user utilized a particular selection mechanism to encircle a position or portion of the web page, and this can cause positional information to be detected.

At 706, the positional information is caused to be transmitted to a server by way of a network connection. At 708, graphical data for display in graphical relation to the position selected by the user is received. This graphical data can include a hyperlink, an advertisement, etc. At 710, the graphical data is displayed on the client computing device in graphical relation to the position on the web page selected by the user. The methodology 700 then completes at 712.

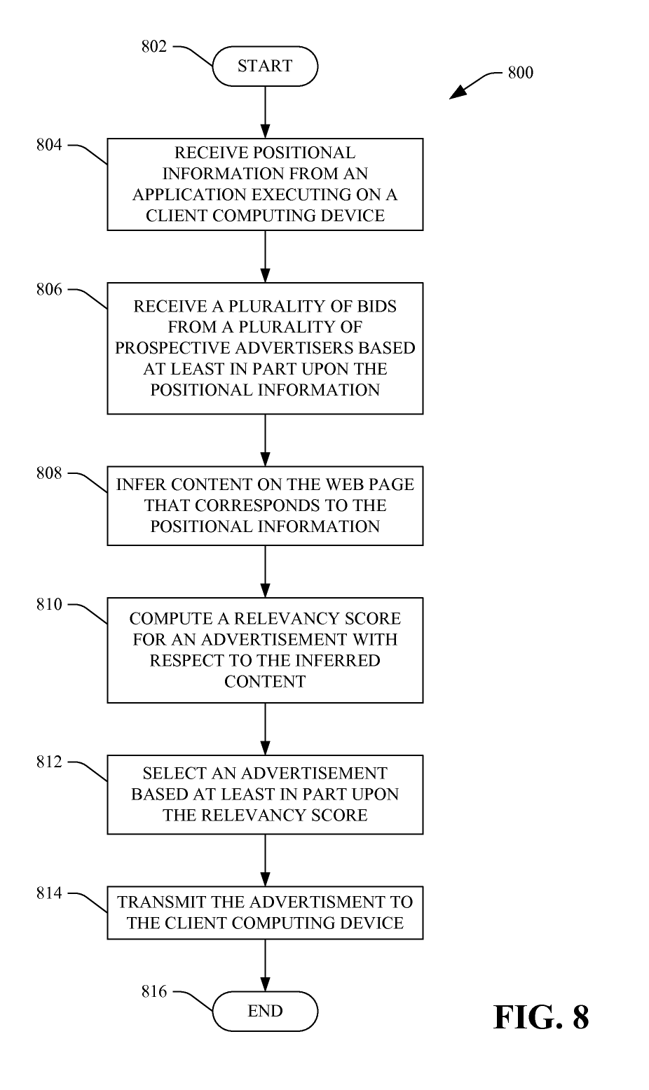

With reference now to FIG. 8, an exemplary methodology 800 that facilitates causing an advertisement to be transmitted to a client computing device based at least in part upon a position on a web page selected by a user is illustrated. For example, the methodology 800 can be configured for execution in an advertisement server. The methodology 800 starts at 802, and at 804 positional information is received from an application executing on a client computing device. The positional information identifies a position of a web page that has been selected by a user of the client computing device, and such positional information is received by an application executing on the client computing device other than a web browser that is employed to load the web page on the client computing device. At 806, subsequent to receiving the positional information, a plurality of bids from a plurality of prospective advertisers is received based at least in part upon the positional information received at 804, wherein the plurality of advertisers desire to cause at least one advertisement to be displayed in graphical relation to the position on the web page selected by the user of the client computing device.

At 808, responsive to receiving the positional information, content on the web page that corresponds to the positional information can be inferred. Several exemplary manners for inferring content corresponding to a positional selection of the user have been described above. At 810, subsequent to receiving the plurality of bids and inferring the content corresponding to the selected position, a relevancy score can be computed that, for each prospective advertisement, is indicative of relevance of the advertisement to the content that is inferred to correspond to the position on the web page. At 812, an advertisement is selected from amongst a plurality of advertisements based at least in part upon amounts of the bids and the relevancy scores computed at 810. At 814, the advertisement is transmitted to the client computing device for display thereon in graphical relation to the position on the web page selected by the user, and the methodology 800 completes at 816.

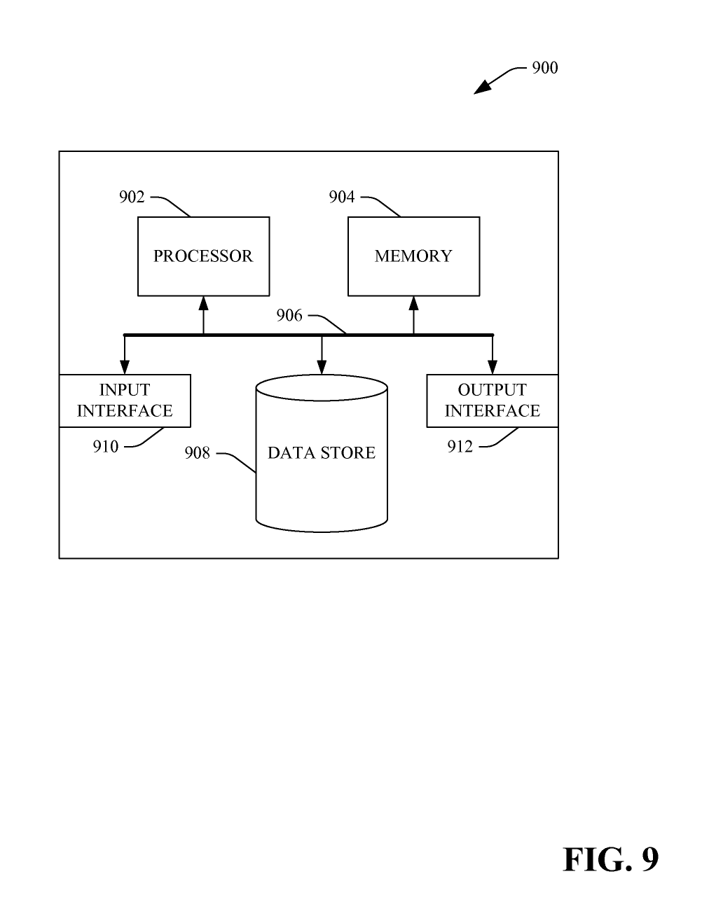

Now referring to FIG. 9, a high-level illustration of an exemplary computing device 900 that can be used in accordance with the systems and methodologies disclosed herein is illustrated. For instance, the computing device 900 may be used in a system that supports detecting a positional selection on a web page from a user. In another example, at least a portion of the computing device 900 may be used in a system that supports conducting an auction based at least in part upon received positional information. The computing device 900 includes at least one processor 902 that executes instructions that are stored in a memory 904. The memory 904 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store templates of web pages, prospective advertisements, etc.

The computing device 900 additionally includes a data store 908 that is accessible by the processor 902 by way of the system bus 906. The data store may be or include any suitable computer-readable storage, including a hard disk, memory, etc. The data store 908 may include executable instructions, templates that describe a known structure/layout of web pages, instructions from service providers, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that facilitates provision of content to a user, the method comprising:
receiving positional information from a client computing device, wherein the positional information indicates a position on a web page that has been selected by the user at the client computing device, and wherein the positional information is received from an entity other than the web page; and
causing graphical data pertaining to content corresponding to the position on the web page to be transmitted to the client computing device for display thereon based at least in part upon the positional information received from the client computing device.

2. The method of claim 1, wherein the graphical data pertaining to content corresponding to the position on the web page is an advertisement.

3. The method of claim 2, further comprising:
prior to causing the graphical data pertaining to the content corresponding to the position on the web page to be transmitted to the client computing device, receiving a plurality of bids from a plurality of advertisers based at least in part upon the positional information; and
selecting the advertisement for transmittal to the client computing device based at least in part upon amounts of bids received from the plurality of advertisers.

4. The method of claim 3, further comprising:
subsequent to receipt of the positional information, computing a relevancy score that indicates a relevance of the advertisement to the content corresponding to the position on the web page, and wherein the advertisement is selected for transmittal to the client computing device based at least in part upon the relevancy score.

5. The method of claim 4, further comprising:
accessing a template that defines a structure/layout of the web page;
inferring the content corresponding to the position on the web page based at least in part upon the structure/layout of the web page as defined by the template; and
computing the relevancy score based at least in part upon the content that is inferred based at least in part upon the structure/layout of the web page defined by the template.

6. The method of claim 4, further comprising:
accessing a search engine index to locate an indexed version of the web page;
determining the content corresponding to the position on the web page in the indexed version of the web page; and
computing the relevancy score based at least in part upon the corresponding to the position on the web page in the stored version of the web page.

7. The method of claim 1 configured for execution in an advertisement server.

8. The method of claim 1, wherein the graphical data pertaining to the content corresponding to the position on the web page comprises a hyperlink to another web page.

9. The method of claim 1, wherein the graphical data pertaining to the content corresponding to the position on the web page is caused to be displayed at the client computing device as an in-line popup.

10. The method of claim 1, further comprising:
prior to causing the graphical data pertaining to the content corresponding to the position on the web page to be transmitted to the client computing device, normalizing the positional information to account for a type of the client computing device to generate normalized positional information; and
causing the data pertaining to the content corresponding to the position on the web page to be transmitted to the client computing device for display thereon based at least in part upon the normalized positional information.

11. The method of claim 1, wherein the entity other than the web page is a computer-executable program executing in a web browser that is displaying the web page at the client computing device.

12. The method of claim 1, wherein the entity other than the web page is an operating system that is executing on the client computing device.

13. A system comprising a plurality of components that are executable by a processor, the components comprising:
a receiver component that receives positional information from a client computing device, wherein the positional information is indicative of a position selected by a user on a web page being viewed at the client computing device, and wherein the positional information is received from an entity other than the web page; and
a content provider component that causes graphical data to be transmitted to the client computing device for display in graphical relation to the position selected by the user on the web page, wherein the content provider selects the graphical data for transmittal to the client computing device based at least in part upon the positional information received from the client computing device.

14. The system of claim 13, wherein the entity other than the web page is a computer-executable application executing in a web browser utilized to display the web page at the client computing device, wherein the web page lacks code that calls the computer-executable application.

15. The system of claim 13, wherein the entity other than the web page is an operating system executing on the client computing device.

16. The system of claim 13, wherein the graphical data comprises an advertisement.

17. The system of claim 16, further comprising an auction component that receives bids from a plurality of prospective advertisers, and wherein the content provider component selects the advertisement from amongst a plurality of prospective advertisements based at least in part upon an amount of the bids.

18. The system of claim 16, further comprising a relevancy calculator component that computes a measure of relevancy between the advertisement and content on the web page at the position selected by the user, wherein the content provider component selects the advertisement from amongst a plurality of advertisements based at least in part upon measure of relevancy.

19. The system of claim 18, wherein responsive to the receiver component receiving the positional information, the relevancy calculator component retrieves a template corresponding to the web page from a data store, wherein the template defines a structure/layout of the web page, and wherein the relevancy calculator component computes the measure of relevancy between the advertisement and the content on the web page based at least in part upon the structure/layout of the web page defined by the template.

20. A non-transitory computer-readable medium comprising instructions that, when executed by a processor, cause the processor to perform acts comprising:
receiving positional information from an application executing on a client computing device, wherein the positional information identifies a position on a web page selected by a user of the client computing device, wherein the positional information is received by an application executing on the client computing device other than a web browser that is employed to load the web page on the client computing device;
subsequent to receiving the positional information, receiving a plurality of bids from a respective plurality of advertisers that desire to cause at least one advertisement to be displayed in graphical relation to the position on the web page selected by the user of the client computing device;
responsive to receiving the positional information, inferring content on the web page that corresponds to the position on the web page selected by the user;
subsequent to receiving the plurality of bids and inferring the content on the web page, computing a relevancy score that, for each prospective advertisement, is indicative of relevance of an advertisement to the content that is inferred to be on the web page;
selecting an advertisement from amongst a plurality of advertisements based at least in part upon amounts of the bids and the relevancy score; and
transmitting the advertisement to the client computing device for display thereon.
